(19) United States
(12) Patent Application Publication
(10) Pub. No.: US 2012/0232806 A1
(43) Pub. Date: Sep. 13, 2012

(54) SYSTEM AND METHOD FOR ANALYZING AND RETRIEVING DATA OBTAINED FROM TURBINE OPERATIONS

(75) Inventors: Jayanthi Srinivasan, Virginia Beach, VA (US); Leon Ericson Haynes, Virginia Beach, VA (US); David Neal Johnson, Frenchtown, MT (US); Charles B. Singleton, Newport News, VA (US); Olga Agady, Virginia Beach, VA (US)

(73) Assignee: GENERAL ELECTRIC COMPANY, Schenectady, NY (US)

(21) Appl. No.: 13/044,924

(22) Filed: Mar. 10, 2011

(51) Int. Cl. G06F 19/00

(52) U.S. Cl. 702/33

(57) ABSTRACT

Systems and methods for analyzing and retrieving data from a monitoring system for monitoring a plurality of rotary machinery, such as turbines, is disclosed. A notification of an anomaly event is received from the monitoring system and tag data associated with the anomaly event is retrieved using a computer-implemented data retrieval tool. The tag data is stored at a central location and one or more objects are generated at the central location according to an event model. The one or more objects are stored as an event data object at the central location. The event data object is accessible by one or more client devices configured to render the one or more objects associated with the event data object in a graphical user interface.

### FIELD OF THE INVENTION

The present disclosure relates generally to systems and methods for monitoring rotary machines, such as turbines, and more particularly to systems and methods for retrieving and analyzing data associated with anomaly events for the rotary machines.

### BACKGROUND OF THE INVENTION

Monitoring systems and tools are used to assess operating conditions of power generation turbine plants. These monitoring systems typically monitor a wide variety of data obtained from sensors associated with the turbine or related components. For instance, the monitoring systems can include sensors that monitor key parameters of the turbines and related components, such as, for instance, vibrational data, operating temperatures, operating speeds, operating pressures, valve and actuator settings, fuel demand, power generation, operational setting percentages, operating states and conditions, and other suitable parameters. The tag data generated by the sensors is collected and analyzed to determine the existence of anomaly events, such as divergence of key parameters from baseline parameters, that may be indicative of a present or future condition that requires maintenance.

Upon the occurrence of an anomaly event, it is desirable to collect and analyze tag data associated with the anomaly event to facilitate diagnosis. Currently, tag data associated with the anomaly must be manually pulled from the monitoring system and manually entered into a separate data analysis tool to run reports and display charts to the user. This not only leads to low productivity, but also results in missed diagnoses and delayed detection of critical events.

Several attempts have been made in the past to address the display of tag data associated with anomaly events. One current solution fetches tag data on demand and displays it to the user. This tool is limited in scope for several reasons. First, a user must first request data for a particular unit without knowing if the reported anomaly event is valid. Second, the specialist must wait an extended period of time for the data to displayed. In one particular implementation of this solution, the application is deployed locally on user machines. This version reads off a spreadsheet to determine the existence of an anomaly event and pulls tag data accordingly. This tool does not get real time notification of events from the monitoring system and is not scalable.

Thus, a data analysis and retrieval tool that automatically retrieves supporting tag data associated with anomaly event notifications from the monitoring system and provides objects generated from the tag data to a user according to a event model associated with the type of anomaly event would be welcome in the art.

### BRIEF DESCRIPTION OF THE INVENTION

Aspects and advantages of the invention will be set forth in part in the following description, or may be obvious from the description, or may be learned through practice of the invention.

One exemplary embodiment of the present disclosure is directed to a method for retrieving data from a monitoring system for monitoring a plurality of machines, such as turbines. The method includes receiving a notification of an anomaly event from the monitoring system and retrieving tag data associated with the anomaly event from the monitoring system using a computer-implemented data retrieval tool. The method further includes storing the tag data at a central server and generating one or more objects associated with the tag data at the central server according to an event model. The method further includes storing the one or more objects as a single event data object associated with the anomaly event at the central server.

Another exemplary embodiment of the present disclosure is directed to a system for retrieving data from a monitoring system for monitoring a plurality of rotary machines, such as turbines. The system includes a central server comprising a database and a first communication link between said central server and the monitoring system. The central server is configured to receive a notification of an anomaly event from the monitoring system over the first communication link. The central server further includes a data collection engine configured to retrieve tag data associated with the anomaly event from the monitoring system and to store the tag data in the database. The central server further includes a computer readable medium comprising executable instructions configured to control the central server to generate one or more objects associated with the tag data according to an event model and to store the one or more objects as a single event data object associated with the anomaly event in the database.

A further exemplary embodiment of the present disclosure is directed to a method for retrieving data from a monitoring system for monitoring a plurality of rotary machines. The method includes receiving a push notification of an anomaly event from the monitoring system and retrieving tag data associated with the anomaly event from the monitoring system using a computer-implemented data retrieval tool. The method further includes storing the tag data at a central server. The method further includes determining an event type associated with the anomaly event; identifying one or more objects associated with the event type by an event model; and generating the one or more objects associated with event type according to the event model using the retrieved tag data. The method further includes storing the one or more objects as a single event data object associated with the anomaly event at the central server. The single event data object is accessible by a client device configured to render the one or more objects associated with the event data object in a graphical user interface.

Variations and modifications can be made to these exemplary embodiments of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1—depicts a block diagram of an exemplary system according to an exemplary embodiment of the present disclosure;

FIG. 2—depicts a flow diagram of An exemplary method according to an exemplary embodiment of the present disclosure;

FIG. 3—depicts a flow diagram of an exemplary method according to an exemplary embodiment of the present disclosure;

FIG. 4—depicts a flow diagram of an exemplary method according to an exemplary embodiment of the present disclosure;

FIG. 5—depicts a flow diagram of an exemplary method according to an exemplary embodiment of the present disclosure;

FIG. 6—depicts an exemplary screen shot of a graphical user interface displaying a list of anomaly events according to an exemplary embodiment of the present disclosure; and

FIG. 7—depicts an exemplary screen shot of a graphical user interface displaying rendered objects associated with an event data object according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to a system and method for data analysis and retrieval from a monitoring system used to monitor various parameters of rotary machines, such as turbines. The monitoring system includes a plurality of sensors that generate data associated with one or more turbines and related components. Tag data refers to the data generated by the plurality of sensors and can include data such as vibrational data, operating temperature data, operating speed data, operating pressure data, valve and actuator setting data, fuel demand data, power generation data, operational setting percentage data, operating state and condition data, and other suitable data.

The monitoring system tracks parameters associated with the rotary machines and related components to determine if any monitored parameters deviate from baseline parameters. An anomaly event can occur when there is a deviation from any of the baseline parameters. For instance, a combustion anomaly event can occur if one or more parameters associated with the combustion of a gas turbine have deviated from baseline parameters. A vibration anomaly event can occur if one or more parameters associated with the vibration of a gas turbine have deviated from baseline parameters.

Anomaly events can be assigned a priority level based on severity of the deviation from the baseline parameters. For instance, an exception anomaly event can indicate that a relatively minor deviation from baseline parameters has occurred. An alarm anomaly event can indicate that a significant deviation from baseline parameters has occurred.

The systems and methods of the present disclosure provide a data analysis and retrieval tool that receives notification of an anomaly event from the monitoring system and facilitates presentation of the tag data associated with the anomaly event to a user. The data analysis and retrieval tool includes a central server that registers as an agent to receive anomaly event updates from the monitoring system. Upon receipt of a notification that an anomaly event has occurred, the central server sends an update of a list of anomaly events to one or more client devices and launches a thread process to fetch tag data associated with the event from the monitoring system. Once the data retrieval is complete, the central server pre-creates one or more objects, such as chart objects, plot objects, list objects, or other suitable objects, in accordance with a configurable event model.

The configurable event model specifies one or more objects to be generated depending on the anomaly event type and other parameters. A user can define the configurable event model so that various desired objects created from tag data, such as charts, lists, plots, or other suitable objects, can be generated at the central server upon receipt of tag data associated with the anomaly event. The one or more objects are stored as a single event data object at the central server.

The client device displays a list of anomaly events on a graphical user interface to the user. When the user selects one of the anomaly events, the client device requests access to the single event data object stored at the central server. When the client device receives the single event data object, the client device stores the data locally and renders the one or more objects associated with the event data object on the graphical user interface. For example, the client device may display one or more of the charts, lists, plots, or other suitable objects associated with the anomaly event to the user. Once the one or more objects have been rendered in a graphical user interface, a user can have the ability to perform filtering operations, to hide or to unhide certain tag data associated with the objects, and to perform other operations, such as zooming in and out of chart objects displayed on the graphical user interface. The client device can also create a spreadsheet template and export the data associated with the event data object to the spreadsheet for storage locally at the client device.

In this manner, the data analysis and retrieval tool provides a system and method that allows a user to efficiently receive and analyze tag data associated with a particular anomaly event. Advantages of the data analysis and retrieval tool of the present disclosure include the ability to provide near real time updates from the monitoring system and to allow for the auto pull of tag data from the monitoring system with no manual intervention. This enhances on-time detection and diagnosis of anomaly events. A further advantage of the data analysis and retrieval tool of the present disclosure is the ability to configure different types of alarm categories or types and to specify particular objects to be generated from tag data for each alarm type through a configurable event model.

The present disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

When data is obtained or accessed between first and second components, the actual data may travel between the systems directly or indirectly. For example, if a first device accesses a file or data from a second device, the access may involve one or more intermediary devices, proxies, and the like. The actual file or data may move between the computers, or one computer may provide a pointer or metafile that the other computer uses to access the actual data from a still further computer.

The various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality complementary or unrelated to the present subject matter, as well. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, some embodiments of the methods and systems set forth herein may also be implemented by hard-wired logic or other circuitry, including, but not limited to application-specific circuits. Of course, combinations of computer-executed software and hard-wired logic or other circuitry may be suitable, as well.

Embodiments of the methods disclosed herein may be executed by one or more suitable computing devices. Such system(s) may comprise one or more computing devices adapted to perform one or more embodiments of the methods disclosed herein. As noted above, such devices may access one or more computer-readable media that embody computer-readable instructions which, when executed by at least one computer, cause the computer(s) to implement one or more embodiments of the methods of the present subject matter. Additionally or alternatively, the computing device(s) may comprise circuitry that renders the device(s) operative to implement one or more of the methods of the present subject matter. Furthermore, components of the presently-disclosed technology may be implemented using one or more computer-readable media.

Any suitable computer-readable medium or media may be used to implement or practice the presently-disclosed subject matter, including, but not limited to, diskettes, drives, and other magnetic-based storage media, optical storage media, including disks (including CD-ROMs, DVD-ROMs, and variants thereof), flash, RAM, ROM, and other memory devices, and the like.

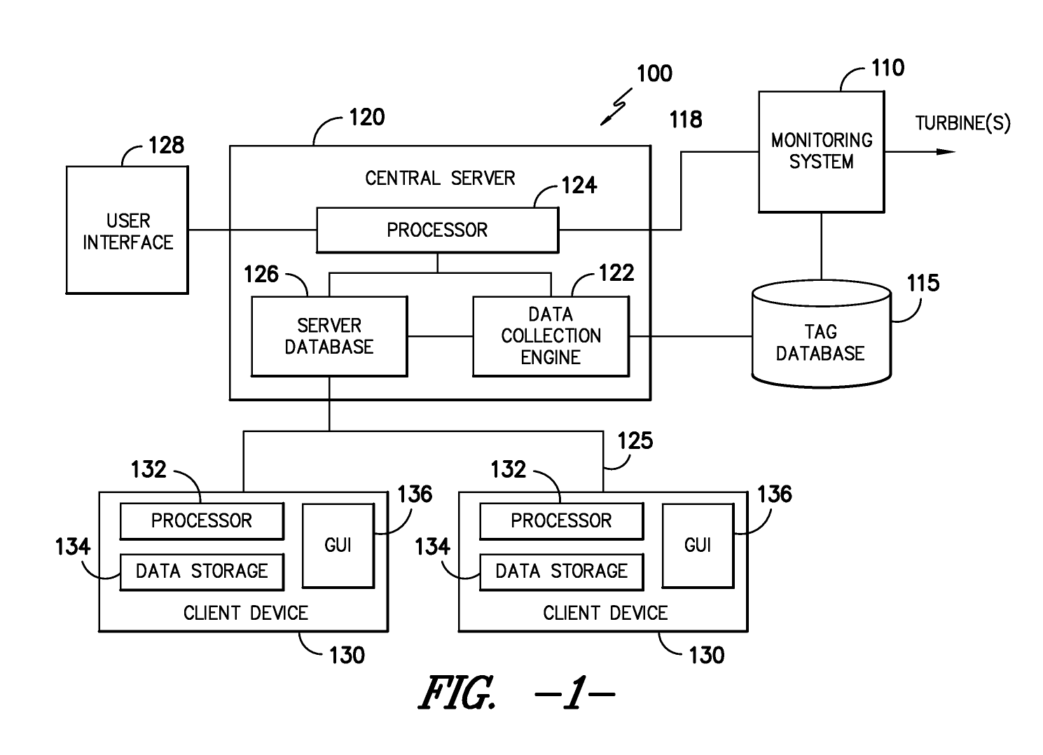

FIG. 1—illustrates a block diagram of an exemplary system 100 according to an exemplary embodiment of the present disclosure. System 100 includes a central server 120 and one or more remote client devices 130. While two remote client devices 130 are illustrated in FIG. 1—, those of ordinary skill in the art, using the disclosures provided herein, should understand that any number of remote client devices 130 can be used without deviating from the scope of the present disclosure.

Central server 120 is coupled to monitoring system 110 through communication link 118. Communication link 118 can be any of a number and/or combination of wired, wireless, or other suitable communication links. Monitoring system 110 is used to monitor various operating parameters of rotary machinery, such as turbines. The monitoring system 110 can include a plurality of sensors (not illustrated) that monitor various parameters of the rotary machinery and related components. The tag data obtained from the sensors can be stored in a tag database 115 as it is collected by the monitoring system.

Central server 120 can include various components, such as a data collection engine 122, a processor 124, a server database 126, and a user interface 128. Data collection engine 122 can be any computer-implemented tool used to retrieve tag data from tag database 115. For instance, if central server 120 receives a notification from monitoring system 110 of an anomaly event, data collection engine 122 can be used to fetch tag data associated with that particular anomaly event from tag database 115.

Processor 124 can be any suitable processing device(s) and can be used to execute computer readable instructions to generate one or more objects from the tag data according to a configurable event model. The one or more objects can include chart objects, list objects, plot objects, or other suitable objects desired to be viewed by a user when diagnosing an anomaly event.

The configurable event model specifies one or more objects to be created from the tag data based on parameters specified in the event model. In a particular embodiment, the configurable event model specifies the type of tag data to be retrieved and the type of objects to be generated based at least in part on the anomaly event type. For instance, if the anomaly event is classified as a combustion anomaly event, the configurable event model directs the processor 124 to retrieve tag data of particular concern to combustion type anomaly events and to generate one or more objects associated with a combustion type event in the event model. Similarly, if the anomaly event is classified as a vibration anomaly event, the configurable event model directs the processor 124 to retrieve tag data of particular concern to vibration type anomaly events and to generate one or more objects associated with a vibration type event in the event model.

Once the processor 124 has generated the one or more objects, the processor 124 stores the one or more objects as a single event data object associated with the anomaly event at the central server database 126. In one embodiment, the received tag data and the event data object are stored as a proprietary data structure that is only readable by authorized client devices.

As illustrated, central server 120 can also include or be coupled to user interface 128. User interface 128 can be used to view and analyze tag data and objects stored in central server database 126. User interface 128 can also be used to input instructions and to configure various properties of system 100.

In a particular embodiment, user interface 128 can be used to configure parameters of the event model. For instance, a user can create different anomaly event classifications and configure the event model to associate one or more objects with the different anomaly event classification as desired. As an example, if it is desired to display six different chart objects associated with thermocouple data to a user whenever a combustion type anomaly event occurs, a user can configure the event model to direct processor 124 of central server 120 to generate the six different chart objects associated with thermocouple data whenever a notification of a combustion type anomaly event is received from the monitoring system 110. In this manner, the configurable event model automatically generates objects that will assist a user in diagnosing an anomaly event whenever a notification of the anomaly event occurs. The flexibility provided by the configurable event model allows for the adjustment of system 100 to suit the needs of a particular monitoring program.

Client devices 130 are coupled to central server 120 over a communication link 125. Communication link 125 can be any of a number and/or combination of wired, wireless, or other suitable communication links. Client devices 130 can include a processor 132, a data storage device 134, and a graphical user interface 136.

The client device 130 is configured to receive notification of an anomaly event from the central server 120. For instance, in a particular embodiment, the central server 120 maintains a list of anomaly events and provides the list of anomaly events to each registered client device 130. When central server 120 receives notification of an anomaly event from the monitoring system 110, central server 120 updates the list of anomaly events and provides the updated list of anomaly events to the client devices 130. The list of anomaly events can be displayed on graphical user interface 136 to a user.

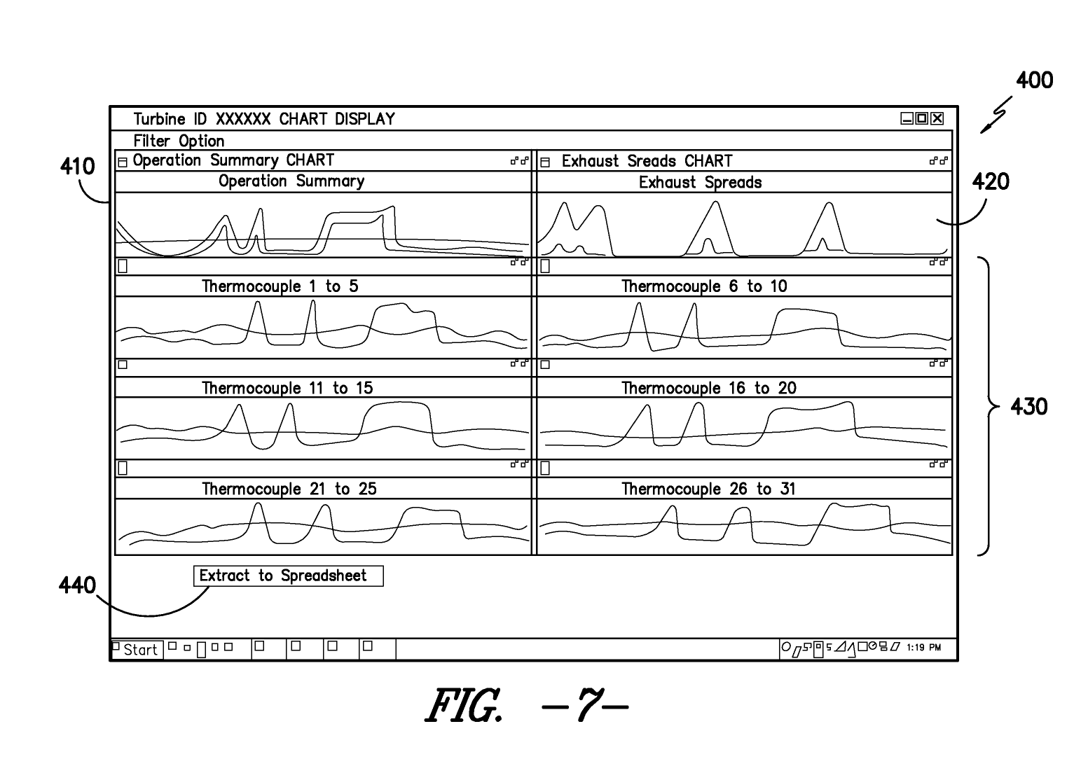

FIG. 6—illustrates an exemplary screen shot 300 of a graphical user interface 136 displaying a list of anomaly events 311. As shown, the list of anomaly events 311 includes an equipment identification field 312, an anomaly event type field 314 and a status field 316. Equipment identification field 312 can notify the user of the particular item of equipment experiencing the anomaly event. The anomaly event type field 314 can notify the user of the particular type of anomaly event, such as a combustion type anomaly event or a vibration type anomaly event. The status field 316 can notify the user whether the central server has completed the data pull of tag data associated with the anomaly event. Screenshot 300 also includes a frame 320 that sorts anomaly events by priority and workstation.

After the central server 120 has pulled the necessary tag data, generated one or more objects from the tag data according to the event model, and stored the one or more objects as a single event data object, the client devices 130 can obtain access to the single event data object and associated tag data. A user can request access to the single event data object by selecting a particular anomaly event from the list of anomaly events displayed on the graphical user interface 136 of client device 130. The client device processor 132 stores the event data object received from the central server and associated tag data in data storage device 134. The processor 132 then renders the one or more objects associated with the event data object in the graphical user interface 136.

FIG. 7—depicts an exemplary screen shot 400 of a graphical user interface 136 displaying a plurality of objects associated with a particular anomaly event to a user. Screen shot 400 includes a chart object 410 that provides operation summary data and a chart object 420 that provides exhaust spread data. Chart objects 430 display thermocouple data associated with various thermocouples used as part of the monitoring system 110. The chart objects 410, 420, and 430 are automatically generated at the central server without requiring the manual pull of tag data and manual creation of the chart objects from the tag data.

Once the one or more objects have been rendered in a graphical user interface, a user can have the ability to perform filtering operations, to hide or to unhide certain tag data associated with the objects, and to perform other operations, such as zooming in and out of chart objects. The display of objects associated with the tag data on the graphical user interface provides for more efficient analysis of anomaly events.

The client device processor 132 can further be configured to generate a spreadsheet template for the tag data associated with the anomaly event. When requested by a user, the client device processer 132 can provide the tag data associated with an event data object received from the central server 120 to the spreadsheet. For instance, as shown in FIG. 7—, a user can populate the spreadsheet by selecting the “Extract to Spreadsheet” icon 440. In this manner, the data analysis and retrieval tool can automatically generate spreadsheets of tag associated with an anomaly event, facilitating diagnosis and resolution of the anomaly without the need for manually pulling the data and entering the data into the spreadsheet.

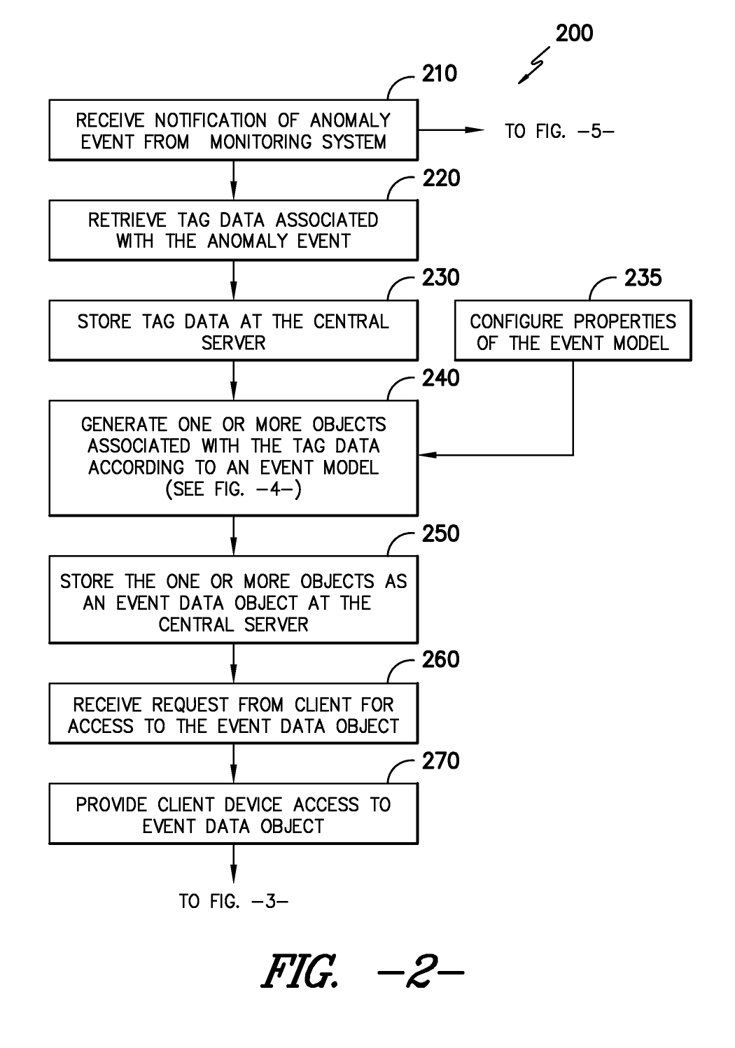

With reference to FIGS. 2-5 an exemplary method 200 executed by system 100 according to an exemplary embodiment of the present disclosure will be discussed. At 210, the central server 120 receives notification of an anomaly event from the monitoring system 110. The central server 120 can receive a push notification from the monitoring system 110 whenever an anomaly event occurs. Alternatively, the central server 120 can periodically query the monitoring system 110 for anomaly event data.

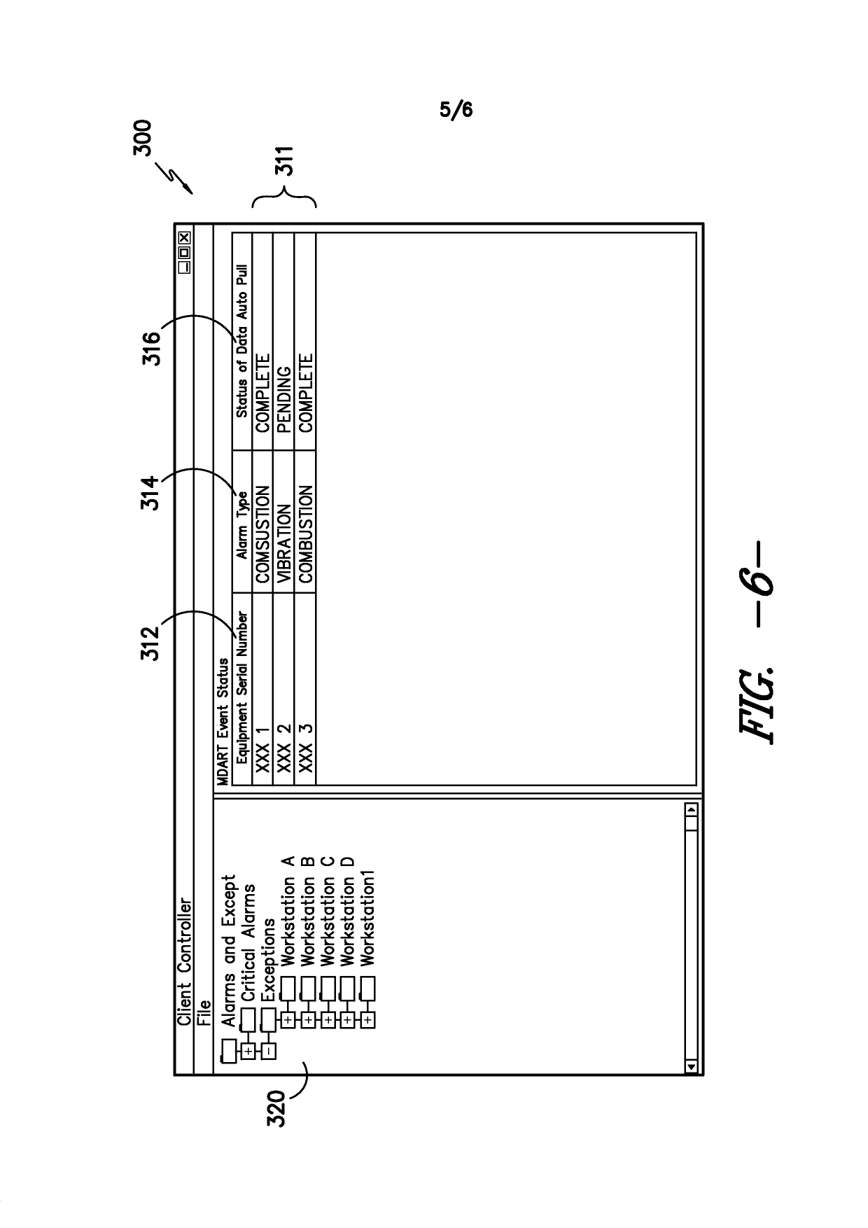

Referring to FIG. 5—at 212, the central server 120 adds the anomaly event to a list of anomaly events maintained at the central server. In particular embodiments, the central server 120 can remove false positive anomaly events from the list of anomaly events as shown at 214 and remove resolved anomaly events from the list of anomaly events as shown at 216. At 218, the central server 120 provides the updated list of anomaly events to registered client devices 130. In this manner, the client devices 130 receive an accurate and up to date anomaly event list that does not include false positive anomaly events or resolved anomaly events.

Referring back to FIG. 2—at 220, the central server 120 retrieves tag data associated with the anomaly event from tag database 115. The central server 120 uses a computer-implemented data retrieval tool to fetch the tag data associated with the particular anomaly event. In a particular embodiment, the computer-implemented data retrieval tool can be programmed to receive particular tag data depending on the type and status of the anomaly event. At 230, the central server 120 stores the tag data, for instance, at the central server database 126.

At 240, the central server 120 generates one or more objects from the tag data according to an event model. As discussed above, the event model specifies one or more objects to be created from the tag data based on parameters specified in the event model. As shown at 235, the method 200 can further include adjusting one or more parameters of the event model to tailor the event model to the specific needs of a particular monitoring program. For instance, a user can configure the event model to associate one or more types of objects with an anomaly type so that the central server automatically generates the one or more objects whenever a particular anomaly event type occurs.

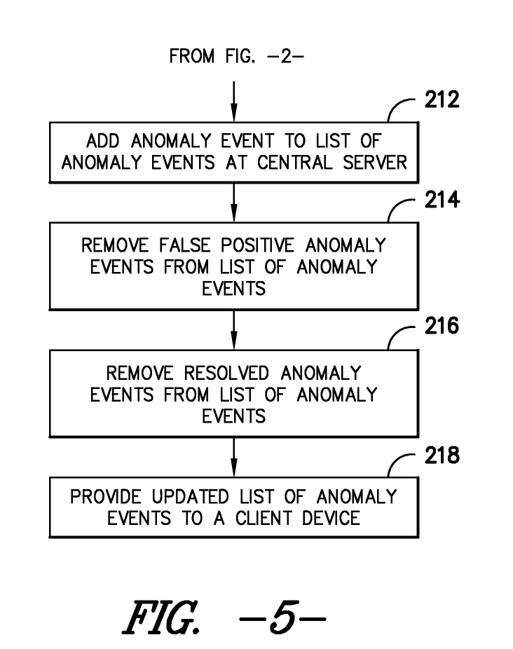

FIG. 4—illustrates exemplary method steps for generating one or more objects from tag data according to an event model according to a particular embodiment of the present disclosure. At 242, the central server 120 determines an event type associated with the anomaly event. For instance, the central server 120 determines whether the anomaly event is an alarm anomaly event or an exception anomaly event. Alternatively, the central server 120 can determine whether the anomaly event is a vibration type anomaly event or a combustion type anomaly event. Those of ordinary skill in the art, using the disclosures provided herein, should understand that there is an infinite range of classifications of anomaly events and that the present disclosure is not limited to any particular set of anomaly event classifications.

At 244, the central server 120 identifies one or more objects associated with the anomaly type in the event model. For example, if the event model specifies five different chart objects with the particular anomaly type, the central server 120 will be commanded to generate those five different chart objects from the tag data when the anomaly event occurs. At 246, the central server 120 generates the one or more objects associated with the anomaly event type.

Referring back to FIG. 2—at 250, the central server 120 stores the one or more objects as a single event data object at the central server 120. The single event data object and associated tag data can be stored in a proprietary file format that is only readable by registered client devices. At 260 the central server 120 receives a request from a client device 130 for access to the single event data object and associated tag data. At 270, the central server provides the client device 130 access to the event data object and provides the event data object to the client device 130.

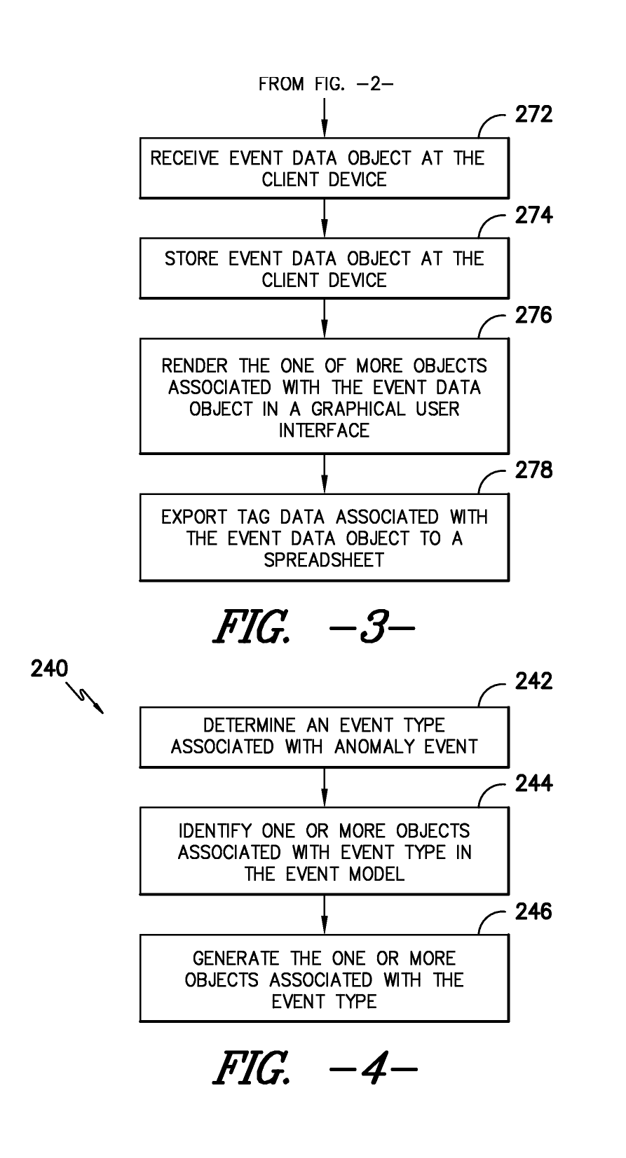

Referring to FIG. 3 at 272, the client device 130 receives the event data object at the client device 130 and at 274 stores the event data object and any associated tag data at the client device 130. At 276, the client device 130 renders the one or more objects associated with the event data object in a graphical user interface. For instance, the client device 130 may display one or more chart objects for the anomaly event in a graphical user interface to facilitate diagnosis of the anomaly event. At 278, the client device 130 can export the tag data associated with the anomaly event to a spreadsheet for use locally at the client device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for retrieving data from a monitoring system for monitoring a plurality of machines, comprising:
receiving a notification of an anomaly event from the monitoring system;
retrieving tag data associated with the anomaly event from the monitoring system using a computer-implemented data retrieval tool;
storing the tag data at a central server;
generating one or more objects from the tag data at the central server according to an event model; and
storing the one or more objects as an event data object associated with the anomaly event at the central server.

2. The method of claim 1, wherein generating one or more objects associated with the tag data at the central server according to an event model, comprises:
determining an event type associated with the anomaly event;
identifying one or more objects associated with the event type in the event model; and
generating the one or more objects associated with event type.

3. The method of claim 1, wherein the method comprises adjusting at least one parameter of the event model.

4. The method of claim 1, wherein the one or more objects associated with the tag data comprise chart objects.

5. The method of claim 1, wherein the method further comprises:
receiving a request from a client device for access to the event data object; and
providing the client device access to the event data object.

6. The method of claim 5, wherein the method further comprises:
storing the event data object at the client device; and
rendering the one or more objects associated with the event data object at the client device.

7. The method of claim 5, wherein the method further comprises:
creating a spreadsheet template at the client device for the tag data;
providing tag data associated with the event data object to the spreadsheet template.

8. The method of claim 1, wherein the method comprises:
maintaining a list of anomaly events at the central server;
updating the list of anomaly events at the central server; and
providing the updated event list to a client device in operable communication with the central server.

9. The method of claim 8, wherein updating the list of anomaly events at the central server based on information received from the monitoring system comprises at least one of:
adding an anomaly event to the list of anomaly events when the notification of an anomaly event is received from the monitoring system;
removing false positive anomaly events from the list of anomaly events; or
removing resolved anomaly events from the list of anomaly events.

10. A system for retrieving data from a monitoring system for monitoring a plurality of rotary machines, comprising:
a central server comprising a database and a first communication link between said central server and the monitoring system, said central server configured to receive a notification of an anomaly event from the monitoring system over said first communication link, said central server further comprising:
a data collection engine configured to retrieve tag data associated with the anomaly event from the monitoring system and to store the tag data in said database; and
a computer readable medium comprising executable instructions configured to control said central server to generate one or more objects from the tag data according to an event model and to store the one or more objects as an event data object associated with the anomaly event in said database.

11. The system of claim 10, wherein said executable instructions are further configured to control said central server to:
determine an event type associated with the anomaly event;
identify one or more objects associated with the event type in the event model; and
generate one or more objects associated with the event type by the event model.

12. The system of claim 10, wherein said central server further comprises a user interface, said user interface configured to receive instructions from a user to configure one or more parameters of the event model.

13. The system of claim 10, wherein the one or more objects comprise chart objects.

14. The system of claim 10, wherein the system further comprises a client device and a second communication link between said client device and said central server, said central server configured to receive a request from said client device for access to the event data object and to push the event data object to said client device.

15. The system of claim 14, wherein said client device comprises a processing device configured to:
store the event data object at the client device; and
render the one or more objects associated with the event data object in a graphical user interface.

16. The system of claim 14, wherein the client device comprises a processing device configured to:
create a spreadsheet template at the client device for the event data; and
provide the tag data associated event data object to the spreadsheet template.

17. The system of claim 1, wherein said executable instructions are configured to control said central server to:
maintain a list of anomaly events at the central server;
update the list of anomaly events at the central server; and
provide the updated list of anomaly event to a client device over a second communication link.

18. The system of claim 17, wherein said executable instructions are configure to control said central server to update the list of anomaly events at said central server by controlling said central server to perform at least one of:
adding an anomaly event to the list of anomaly events when the notification of an anomaly event is received from the monitoring system;
removing false positive anomaly events from the list of anomaly events; or removing resolved anomaly events from the list of anomaly events.

19. A method for retrieving data from a monitoring system for monitoring a plurality of rotary machines, the method comprising:
receiving a push notification of an anomaly event from the monitoring system;
retrieving tag data associated with the anomaly event from the monitoring system using a computer-implemented data retrieval tool;
storing the tag data at a central server;
determining an event type associated with the anomaly event;
identifying one or more objects associated with the event type by an event model;
generating the one or more objects associated with event type according to the event model using the retrieved tag data; and
storing the one or more objects as a single event data object associated with the anomaly event at the central server;
wherein the single event data object is accessible by a client device configured to render the one or more objects associated with the event data object in a graphical user interface.

20. The method of claim 19, wherein the one or more objects comprise chart objects.
